(19) United States
(12) Patent Application Publication
(10) Pub. No.: US 2026/0079616 A1
(43) Pub. Date: Mar. 19, 2026

(54) IMAGE PROCESSING APPARATUS, CONTROL METHOD, AND NON-TRANSITORY COMPUTER READABLE MEDIUM

(71) Applicant: CANON KABUSHIKI KAISHA, Tokyo (JP)

(72) Inventor: AYUMI SUZUKI, Kanagawa (JP)

(21) Appl. No.: 19/327,336

(22) Filed: Sep. 12, 2025

(30) Foreign Application Priority Data
Sep. 17, 2024 (JP) 2024-159951

(51) Int. Cl. G06F 3/04845; G06F 3/04883; G06T 3/40; G06T 3/60

(52) U.S. Cl. CPC G06F 3/04845; G06F 3/04883; G06T 3/40; G06T 3/60; G06F 2203/04808; G06T 2200/24

(57) ABSTRACT

An image processing apparatus detects an operation including a touch on a display, performs control to display one or more images on the display, performs control to display first and second display items at a position corresponding to a selected image in response to one of the one or more images being selected as the selected image, switches a state regarding a first control between an enabled state and a disabled state if the first display item is tapped, switches a state regarding a second control between an enabled state and a disabled state if the second display item is tapped, performs the first control in response to a specific touch operation on the selected image if the first control is in the enabled state, and performs the second control in response to the specific touch operation if the second control is in the enabled state.

### BACKGROUND

### Field of the Technology

The present disclosure relates to an image processing apparatus, a control method, and a non-transitory computer readable medium.

### DESCRIPTION OF THE RELATED ART

When creating a layout of images, it is sometimes necessary to rotate or scale (enlarge or reduce) the images to be used. Certain image editing applications implement both rotation and scaling (enlargement and/or reduction) exclusively via two-finger touch gestures, thereby eliminating the need for dedicated rotation control components.

In Japanese Patent Laid-Open No. 2016-164702, the operation mode switches between a rotation mode and a scaling mode depending on whether the first-detected touch of two touch points is released or the subsequently-detected touch is released. Subsequently, by moving either of the two touch points, including the newly added touch point, rotation or scaling is carried out.

However, in Japanese Patent Laid-Open No. 2016-164702, the user needs to remember the operation for switching between rotation mode and scaling mode, which is counterintuitive and involves unfamiliar operations. Furthermore, since rotation and scaling cannot be performed simultaneously, users familiar with performing both rotation and scaling actions using two-finger touch operations may find this frustrating.

### SUMMARY

Embodiments of the present disclosure provide techniques for improving the operability when performing various types of control operations on an image.

The present disclosure in a first aspect provides an image processing apparatus including a processor, and a memory storing a program which, when executed by the processor, causes the image processing apparatus to execute operation processing of detecting an operation including a touch on a display, execute display control processing of performing control to display one or more images on the display, and, in response to one of the one or more images being selected as a selected image, performing control to display a first display item and a second display item at a position corresponding to the selected image, execute switching processing of, (1) if the first display item is tapped, switching a state regarding a first control between an enabled state and a disabled state, and, (2) if the second display item is tapped, switching a state regarding a second control between an enabled state and a disabled state, and execute control processing of, if the first control is in the enabled state, performing the first control on the selected image in response to a specific touch operation on the selected image, and, if the second control is in the enabled state, performing the second control on the selected image in response to the specific touch operation.

The present disclosure in a second aspect provides a control method of an image processing apparatus, the control method including detecting an operation including a touch on a display, performing control to display one or more images on the display, in response to one of the one or more images being selected as a selected image, performing control to display a first display item and a second display item at a position corresponding to the selected image, if the first display item is tapped, switching a state regarding a first control between an enabled state and a disabled state, if the second display item is tapped, switching a state regarding a second control between an enabled state and a disabled state, if the first control is in the enabled state, performing the first control on the selected image in response to a specific touch operation on the selected image, and if the second control is in the enabled state, performing the second control on the selected image in response to the specific touch operation.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a smartphone.

FIGS. 2A to 2D are diagrams illustrating the processing of an image editing application.

FIG. 3 is a flowchart of the processing of a smartphone.

FIG. 4 is a flowchart of a switching event process.

### DESCRIPTION OF THE EMBODIMENTS

Embodiments of the present disclosure will be described below in detail with reference to the accompanying drawings. Note that the embodiments described below are merely examples for realizing the present disclosure, and should be appropriately modified or changed depending on the configuration of the apparatus to which the present disclosure is applied and various conditions. Some embodiments are not limited to the embodiments described below.

Below, operations for rotation and scaling of images using the UI (user interface) of an image editing application on a smartphone 100 will be described.

Configuration of Smartphone 100

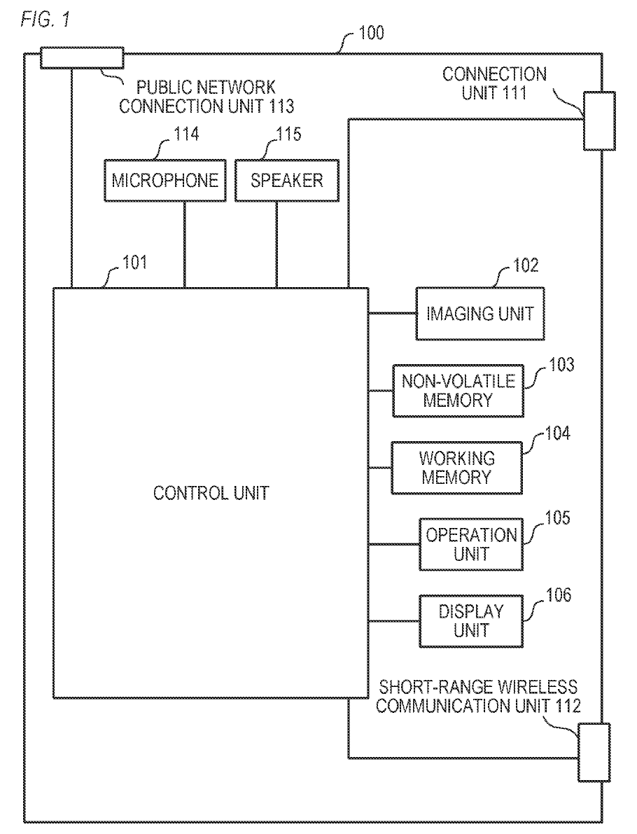

First, with reference to FIG. 1, the configuration and functions of the smartphone 100 will be described. FIG. 1 is a block diagram showing a configuration example of a smartphone 100, which serves as an example of an image processing apparatus. Here, a smartphone is described as an example of an image processing apparatus, but this is not limiting. For example, a tablet device or a personal computer may be used instead of a smartphone.

The smartphone 100 includes a control unit 101, an imaging unit 102, non-volatile memory 103, working memory 104, an operation unit 105, a display unit 106, a connection unit 111, a short-range wireless communication unit 112, a public network connection unit 113, a microphone 114, and a speaker 115.

The control unit 101 controls each component of the smartphone 100 according to input signals or programs described later. Note that, instead of the control unit 101 controlling each component, a plurality of hardware units may share the processing to control each component.

The imaging unit 102 converts light from the subject, which is focused by a lens included in the imaging unit 102 into an electrical signal, and then performs noise reduction processing and other processing on the electrical signal. Thus, the imaging unit 102 captures an image of a subject. The imaging unit 102 outputs the captured digital data as image data. The image data is stored in a buffer memory, and then predetermined processing operations using the image data are performed by the control unit 101.

The non-volatile memory 103 is a non-volatile memory that can be electrically erased and recorded. The non-volatile memory 103 stores the OS (operating system), which is the basic software executed by the control unit 101, as well as applications that realize advanced functions in cooperation with the OS. Additionally, the non-volatile memory 103 stores a program module for the image editing application in the present embodiment. The non-volatile memory 103 stores image data captured by the imaging unit 102 or image data acquired from an external device.

The working memory 104 is used as an image display memory for the display unit 106 or as a work area for the control unit 101.

The operation unit 105 accepts instructions from the user for the smartphone 100. The operation unit 105 includes, for example, a power button for the user to turn the smartphone 100 on or off, and input components such as a touch panel formed on the display unit 106. Therefore, the operation unit 105 can detect touch operations on items displayed on the display unit 106 (for example, images displayed on the display unit 106). The operation unit 105 can, for example, detect taps on display items shown on the display unit 106 and two-finger operations (operations in which the touch positions are changed while touching with two fingers).

The display unit 106 performs functions such as displaying image data and presenting characters for interactive operations. Note that the smartphone 100 is not necessarily required to include the display unit 106. The smartphone 100 need only be capable of connecting to the display unit 106 and controlling the content shown by the display unit 106. In other words, the smartphone 100 only needs to have a display control unit capable of controlling the display unit 106.

The connection unit 111 is a communication interface for connecting to external devices. The connection unit 111 includes one or more communication circuits or communication modules. The connection unit 111, under the control of the control unit 101, performs wireless communication in accordance with, for example, the IEEE802.11x standard (where x is b, a, g, n, ac, and the like). In the present embodiment, the connection unit 111 is used for communication with a public network or an external device via a wireless LAN access point. Here, the public network is a public computer network (for example, the Internet) that the connection unit 111 cannot directly access.

The short-range wireless communication unit 112 includes, for example, an “antenna for wireless communication” and a “modulation/demodulation circuit or communication controller for processing wireless signals.” The short-range wireless communication unit 112 includes, for example, a wireless communication module such as a module conforming to the IEEE802.15 standard (so-called Bluetooth (registered trademark)), an infrared module, or a Wireless USB module. Furthermore, the short-range wireless communication unit 112 may also be configured to enable wired connections using a USB cable, HDMI (registered trademark), IEEE1394, or the like.

The public network connection unit 113 is an interface used when performing public wireless communication. A user using the smartphone 100 can make a call with users of other devices through the public network connection unit 113. At this time, the control unit 101 enables the call by inputting and outputting audio signals via the microphone 114 and speaker 115. In the present embodiment, the public network connection unit 113 is an antenna. The control unit 101 can connect to the public network via the antenna. Note that the connection unit 111 and the public network connection unit 113 can be implemented using a single antenna.

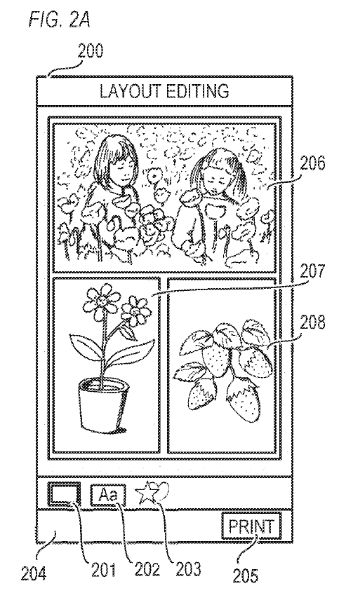

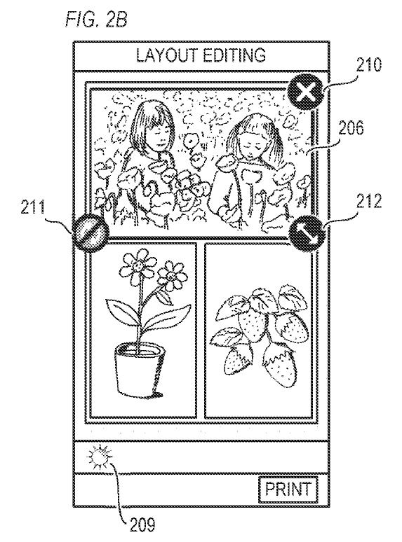

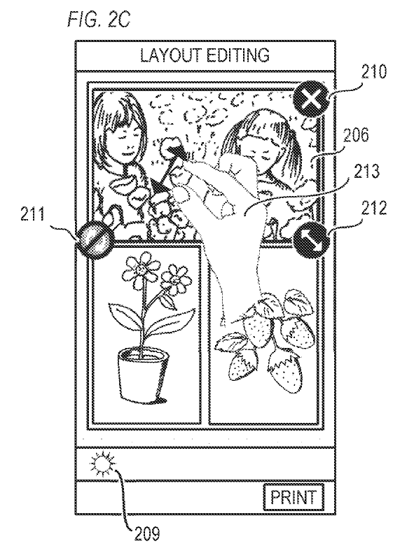

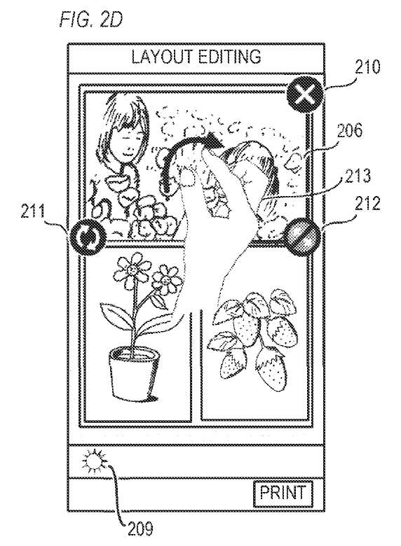

Next, with reference to FIGS. 2A to 2D, the processing of the image editing application on the smartphone 100 will be described. FIGS. 2A to 2D are examples of screen displays of the image editing application. FIG. 2A shows a layout editing screen 200 that is displayed after the image editing application is launched and a selected image is specified from images stored in the non-volatile memory 103 or an external device. When multiple images are specified, multiple images are displayed in a layout specified by the user, or in a layout according to the number of specified images or the aspect ratio of the images. Immediately after the display of the layout editing screen 200 starts, none of the images are in a selection state, and the screen appears as shown in FIG. 2A.

Buttons 201 to 203 are function buttons related to the overall layout. Button 201 is a button for changing the border setting (frame setting) of the image. By tapping button 201, the user can set the border to be shown or hidden, or select the border size. Button 202 is a text placement button. By tapping button 202, the user can add text entered by the user. Button 203 is a stamp placement button. By tapping button 203, the user can select and add a desired stamp.

Button 204 is a settings button for the image editing application. By tapping button 204, the user can set the print size. By tapping button 204, the user can also set the default (initial) enable/disable state of the “rotation control state” and “scaling control state” described later, as well as the visibility of specific display items. Button 205 is a print button. Button 205 is a button for executing printing to a connected printer after layout editing is completed.

Although not described here, a button for SNS (Social Networking Service) integration functions may be provided. When the SNS integration function button is tapped, the image after layout editing is completed can be uploaded to SNS or shared with applications such as email.

Images 206 to 208 are images specified by the user from multiple images stored in the non-volatile memory 103 or an external device, and are arranged on the layout editing screen 200.

Here, when the user taps image 206 on the screen shown in FIG. 2A, the screen transitions to that shown in FIG. 2B. That is, image 206 transitions to a selection state indicating that it is the operation target, and a delete button 210, rotation button 211, and scaling button 212 are displayed at one of the four corners of image 206. Also, buttons 201 to 203 are hidden. For the image in the selection state (hereinafter referred to as “selected image”), a button 209 for adjusting the appearance of the image, such as brightness or contrast, is displayed.

The delete button 210 is a button for deleting an image. When the delete button 210 is tapped, the selected image is deleted (hidden). After the selected image is deleted, the layout may be displayed in a state where the selected image does not exist, without changing from before the deletion of the selected image. Alternatively, the remaining images 207 and 208 may be rearranged in a layout suitable for two images.

The rotation button 211 is a button (display item) for switching the “rotation control state” of the selected image. The “rotation control state” indicates whether the selected image can be rotated by a two-finger operation (an operation in which the selected image is touched with two fingers and the touch positions are changed). If the “rotation control state” is enabled, the selected image can be rotated by a two-finger operation. If the “rotation control state” is disabled, rotation of the selected image by two-finger operation is not possible. When the “rotation control state” is enabled, the rotation button 211 is set to the enabled state as shown in FIG. 2D. When the “rotation control state” is disabled, the rotation button 211 is set to the disabled state as shown in FIG. 2C. In other words, the “rotation control state” and the state of the rotation button 211 remain synchronized.

The scaling button 212 is a button (display item) for switching the “scaling control state” of the selected image. If the “scaling control state” is enabled, the selected image can be enlarged or reduced (i.e., its display magnification can be changed) using a two-finger operation. If the “scaling control state” is disabled, the selected image cannot be enlarged or reduced by a two-finger operation. The scaling button 212 is set to the enabled state as shown in FIG. 2C. If the “scaling control state” is disabled, the scaling button 212 is set to the disabled state as shown in FIG. 2D. In other words, the “scaling control state” and the state of the scaling button 212 is synchronized.

As shown in FIG. 2C, in the present embodiment, when an image enters the selection state, the rotation button 211 is initially set to a disabled state and the scaling button 212 is set to an enabled state. In this state, scaling of the selected image can be performed by operation with the hand 213, but rotation is disabled. Also, as shown in FIG. 2D, when the rotation button 211 is set to the enabled state and the scaling button 212 is set to the disabled state, rotation of the selected image can be performed by operation with the hand 213, but scaling is disabled.

The states of the rotation button 211 and scaling button 212 (“rotation control state” and “scaling control state”) are stored for each image. For example, when the state shown in FIG. 2D with image 206 selected transitions to image 207 being tapped, the selected image switches to image 207. Even if buttons are displayed at the four corners of image 207, the rotation button 211 is set to the disabled state and the scaling button 212 is set to the enabled state. In other words, from the current state, the rotation button 211 and scaling button 212 switch to the state associated with image 207 (in this example, the initial state). Thereafter, if image 206 is tapped and the selected image switches back to image 206, the rotation button 211 arranged at the four corners of image 206 is set to the enabled state and the scaling button 212 is set to the disabled state, as was the case when image 206 was previously in the selection state.

Note that, in the present embodiment, the delete button 210, rotation button 211, and scaling button 212 are arranged at the four corners of the selected image. However, it is sufficient that these buttons are arranged in a way that the corresponding image (the associated image) can be recognized.

Additionally, the rotation button 211 and scaling button 212 may not only switch the enable/disable state of image control when tapped, but may also be buttons for directly performing image rotation and enlargement (or reduction). For example, when a swipe operation is performed on the rotation button 211 as if to rotate the selected image, the control unit 101 may rotate the selected image in response to the change in the touch position. When a flick operation is performed on the rotation button 211, the control unit 101 may rotate the selected image by 90 degrees in the direction of the flick operation. Also, if the finger is moved in the direction of enlargement or reduction while touching the scaling button 212, the control unit 101 may enlarge or reduce the selected image in response to the movement of the finger. Furthermore, when a double tap is performed on the scaling button 212, the control unit 101 may change the size of the selected image to a specific size. In this way, if rotation and enlargement of the selected image are possible through operations other than a normal tap (such as swipe or flick operations) on the buttons, even users unfamiliar with two-finger operations can easily rotate and enlarge the selected image.

Additionally, the user may be allowed to arbitrarily set the initial (default) settings for the state of the rotation button (= rotation control state) and the scaling button (= scaling control state). For example, a user who wishes to perform scaling and rotation simultaneously may set both the rotation button (= rotation control state) and the scaling button (= scaling control state) to the enabled state in the initial settings. As a result, the user does not need to change the state of the buttons each time an image is selected, thereby improving usability.

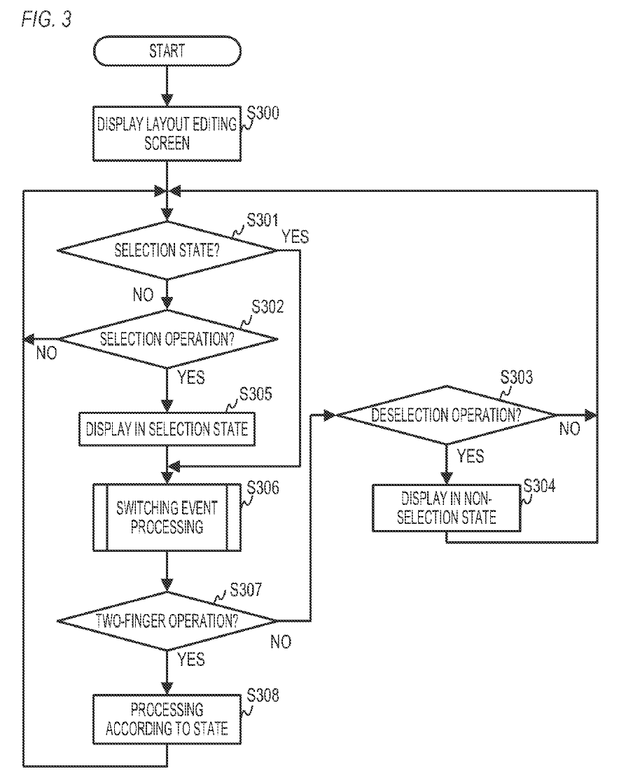

The details of the processing of the smartphone 100 will be described with reference to the flowchart in FIG. 3. Note that all of the processes described below are realized by the control unit 101 of the smartphone 100 controlling the components of the smartphone 100 according to a program stored in the non-volatile memory 103. Also, processes not directly related to the present embodiment are omitted from the description. The flowchart of FIG. 3 shows the processing performed after the user has specified multiple images to be used from images stored in the non-volatile memory 103 or an external device.

In step S300, the control unit 101 displays the layout editing screen on the display unit 106. The layout editing screen corresponds to the screen shown in FIG. 2A.

In step S301, the control unit 101 determines whether one of the multiple images displayed on the display unit 106 is in a selection state. If it is determined that one image is in the selection state, the process proceeds to step S306. If it is determined that no image is in the selection state, the process proceeds to step S302.

In step S302, the control unit 101 determines whether an operation (selection operation) for selecting one of the multiple images displayed on the display unit 106 has been performed. If it is determined that a selection operation has been performed, the process proceeds to step S305. If it is determined that a selection operation has not been performed, the process returns to step S301.

In step S303, the control unit 101 determines whether an operation (deselection operation) for canceling the selection state of an image has been performed. If it is determined that a deselection operation has been performed, the process proceeds to step S304. If it is determined that a deselection operation has not been performed, the process returns to step S301.

In step S304, the control unit 101 displays the layout editing screen (corresponding to the screen shown in FIG. 2A) in which no image is selected.

In step S305, the control unit 101 displays the selection state of the image as shown in FIG. 2B, in response to the image (selected image) selected by the selection operation. At this time, the control unit 101 reads out the states of the rotation button 211 and scaling button 212 associated with the selected image. Then, according to the read states, the control unit 101 displays the rotation button 211 and scaling button 212.

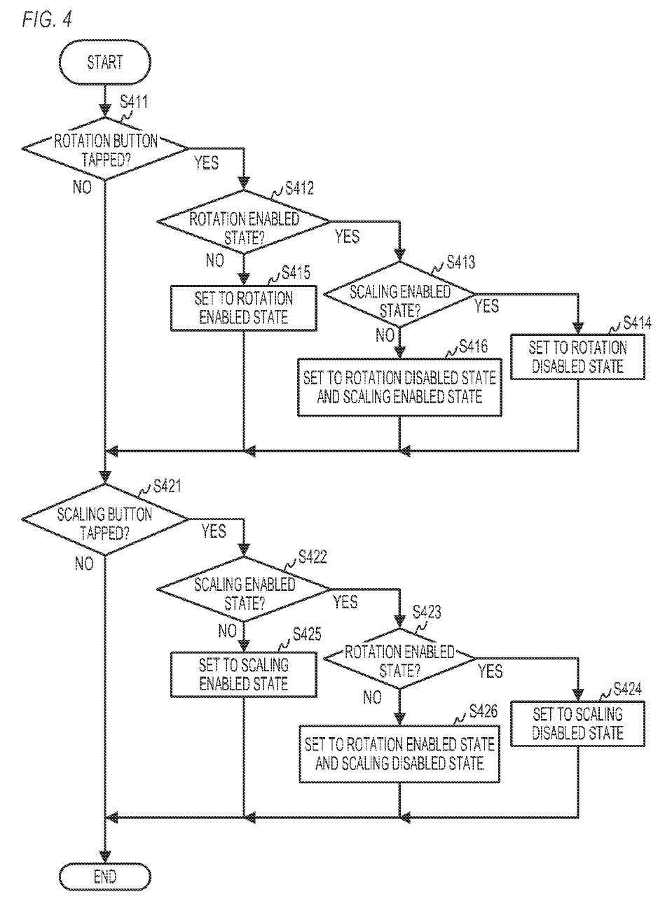

In step S306, the control unit 101 performs a switching event process for switching the “rotation control state” or “scaling control state” for the selected image. The details of the process in step S306 will be described later with reference to the flowchart in FIG. 4. In step S306, the control unit 101 operates as a switching unit for switching the “rotation control state” or “scaling control state,” and as a processing unit for controlling the selected image according to a two-finger operation.

In step S307, the control unit 101 determines whether a two-finger operation, which is an operation involving a touch with two fingers, has been performed. If it is determined that a two-finger operation has been performed, the process proceeds to step S308. If it is determined that a two-finger operation has not been performed, the process returns to step S303.

In step S308, the control unit 101 performs processing according to the “rotation control state” and “scaling control state.” That is, if the “rotation control state” is disabled, the control unit 101 performs only scaling of the selected image in response to the two-finger operation. If the “scaling control state” is disabled, the control unit 101 performs only rotation of the selected image in response to the two-finger operation. If both the “rotation control state” and the “scaling control state” are enabled, the control unit 101 can perform both scaling and rotation of the selected image in response to the two-finger operation.

Note that, in step S307, two-finger operation was described, but as mentioned above, swipe or flick operations on the rotation button or scaling button may also be detected, and processing corresponding to those operations may be performed in step S308. In this case, when rotation is performed by a two-finger operation, the selected image is rotated about the midpoint (center position) of the two fingers, and when a swipe or flick operation is performed on the rotation button, the selected image may be rotated about its center (center position).

Step S306 Processing

Below, the details of the processing in step S306 will be described with reference to the flowchart in FIG. 4.

In step S411, the control unit 101 determines whether the rotation button 211 corresponding to the selected image has been tapped. If it is determined that the rotation button 211 has been tapped, the process proceeds to step S412. If it is determined that the rotation button 211 has not been tapped, the process proceeds to step S421.

In step S412, the control unit 101 determines whether the “rotation control state” of the selected image is enabled (rotation enabled state). If it is determined that the “rotation control state” is enabled (rotation enabled state), the process proceeds to step S413. If it is determined that the “rotation control state” is disabled (rotation disabled state), the process proceeds to step S415.

In step S413, the control unit 101 determines whether the “scaling control state” of the selected image is enabled. If it is determined that the “scaling control state” is enabled (scaling enabled state), the process proceeds to step S414. If it is determined that the “scaling control state” is disabled (scaling disabled state), the process proceeds to step S416.

In step S414, the control unit 101 changes the “rotation control state” to the disabled state.

In step S415, the control unit 101 changes the “rotation control state” to the enabled state.

In step S416, the control unit 101 changes the “rotation control state” to the disabled state and also changes the “scaling control state” to the enabled state.

In step S421, the control unit 101 determines whether the scaling button 212 corresponding to the selected image has been tapped. If it is determined that the scaling button 212 has been tapped, the process proceeds to step S422. If it is determined that the scaling button 212 has not been tapped, the processing of this flowchart ends.

In step S422, the control unit 101 determines whether the “scaling control state” of the selected image is enabled. If it is determined that the “scaling control state” is enabled, the process proceeds to step S423. If it is determined that the “scaling control state” is disabled, the process proceeds to step S425.

In step S423, the control unit 101 determines whether the “rotation control state” of the selected image is enabled (rotation enabled state). If it is determined that the “rotation control state” is enabled, the process proceeds to step S424. If it is determined that the “rotation control state” is disabled, the process proceeds to step S426.

In step S424, the control unit 101 changes the “scaling control state” to the disabled state.

In step S425, the control unit 101 changes the “scaling control state” to the enabled state.

In step S426, the control unit 101 changes the “rotation control state” to the enabled state and also changes the “scaling control state” to the disabled state.

According to the processing in the flowchart of FIG. 4, it is permitted for both the “scaling control state” and the “rotation control state” to be enabled, but it is not permitted for both to be disabled. Therefore, when switching one of the “scaling control state” or the “rotation control state” from enabled to disabled, the other is always set to enabled. This processing is not essential, but in the present embodiment, if both rotation and scaling cannot be performed by two-finger operation, it means that two-finger operation by the user is impossible, resulting in poor usability. However, if other processing (for example, shifting the position of the image up, down, left, or right) can be performed by two-finger operation, it is not necessary for either the “scaling control state” or the “rotation control state” to be enabled.

Note that, when the “scaling control state” or “rotation control state” is changed in steps S414 to S416 or steps S424 to S426, the changed state is stored in association with the selected image. As a result, even when a certain image is newly selected as the selected image, it is possible to restore the “scaling control state” and “rotation control state” to the state they were in when that image was previously selected.

According to the present embodiment, the user can perform operations such as rotation and scaling of images with an intuitive operation feel while viewing the overall layout balance of the images and suppressing erroneous operations.

Note that, in the above, an example was described in which rotation and scaling of the selected image are performed by two-finger operation involving a two-finger touch, but another touch operation may be performed instead of the two-finger operation. Specifically, instead of the two-finger operation, a swipe or flick operation using one finger may be performed, or an operation involving a three-finger touch may be performed. Additionally, instead of controlling rotation and scaling, any control may be performed on the selected image. Specifically, instead of controlling rotation and scaling, adjustment of the brightness of the selected image, adjustment of the contrast of the selected image, or movement of the position of a virtual object displayed on the selected image may be performed.

Additionally, in the above, the phrase “when A is greater than or equal to B, the processing proceeds to step S1, and when A is less than B, the processing proceeds to step S2” may alternatively be construed as “when A is greater than B, the processing proceeds to step S1, and when A is less than or equal to B, the processing proceeds to step S2.” Conversely, the phrase “when A is greater than B, the processing proceeds to step S1, and when A is less than or equal to B, the processing proceeds to step S2” may alternatively be construed as “when A is greater than or equal to B, the processing proceeds to step S1, and when A is less than B, the processing proceeds to step S2.” Accordingly, unless contradiction arises, the phrase “equal to or greater than A” may be construed as “greater than (higher than; longer than; more than) A,” and the phrase “equal to or less than A” may be construed as “less than (lower than; shorter than; fewer than) A.” Similarly, the phrase “greater than (higher than; longer than; more than) A” may be construed as “equal to or greater than A,” and the phrase “less than (lower than; shorter than; fewer than) A” may be construed as “equal to or less than A.”

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, operability when performing various types of control operations on an image is improved.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-159951, which was filed on September 17, 2024 and which is hereby incorporated by reference herein in its entirety.

What is claimed is:

1. An image processing apparatus comprising:
a processor; and
a memory storing a program which, when executed by the processor, causes the image processing apparatus to:
execute operation processing of detecting an operation including a touch on a display;
execute display control processing of performing control to display one or more images on the display, and, in response to one of the one or more images being selected as a selected image, performing control to display a first display item and a second display item at a position corresponding to the selected image;
execute switching processing of, (1) if the first display item is tapped, switching a state regarding a first control between an enabled state and a disabled state, and, (2) if the second display item is tapped, switching a state regarding a second control between an enabled state and a disabled state; and
execute control processing of, if the first control is in the enabled state, performing the first control on the selected image in response to a specific touch operation on the selected image, and, if the second control is in the enabled state, performing the second control on the selected image in response to the specific touch operation.

2. The image processing apparatus according to claim 1, wherein
the specific touch operation is an operation in which a touch position is changed while touching the selected image with two fingers.

3. The image processing apparatus according to claim 1, wherein
the first control is rotation of the selected image, and
the second control is enlargement or reduction of the selected image.

4. The image processing apparatus according to claim 1, wherein
in the switching processing, in a case where an image that has not previously been selected as the selected image is selected as the selected image, initial states are set as the states regarding the first control and the second control.

5. The image processing apparatus according to claim 1, wherein
in the switching processing, in a case where an image that has previously been selected as the selected image is selected as the selected image, the states at the time when the image was previously selected as the selected image are set as the states regarding the first control and the second control.

6. The image processing apparatus according to claim 1, wherein
in the switching processing, in a case where one of the states regarding the first control and the second control is switched to the disabled state, if an other of the states regarding the first control and the second control is in the disabled state, the other is switched to the enabled state.

7. The image processing apparatus according to claim 4, wherein
the initial states of the states regarding the first control and the second control are specifiable by a user.

8. The image processing apparatus according to claim 1, wherein,
in the control processing,
if a swipe operation or a flick operation is performed on the first display item, the first control is performed on the selected image, and
if a swipe operation or a flick operation is performed on the second display item, the second control is performed on the selected image.

9. The image processing apparatus according to claim 8, wherein
the first control is rotation of the selected image, and
in the control processing, a center position of rotation differs between a case where the selected image is rotated in response to the specific touch operation and a case where the selected image is rotated in response to a swipe operation or a flick operation on the first display item.

10. A control method of an image processing apparatus, the control method comprising:
detecting an operation including a touch on a display;
performing control to display one or more images on the display;
in response to one of the one or more images being selected as a selected image, performing control to display a first display item and a second display item at a position corresponding to the selected image;
if the first display item is tapped, switching a state regarding a first control between an enabled state and a disabled state;
if the second display item is tapped, switching a state regarding a second control between an enabled state and a disabled state;
if the first control is in the enabled state, performing the first control on the selected image in response to a specific touch operation on the selected image; and
if the second control is in the enabled state, performing the second control on the selected image in response to the specific touch operation.

11. A non-transitory computer readable medium that stores instructions, wherein the instructions, when executed by a computer, cause the computer to execute a control method, the control method comprising:
detecting an operation including a touch on a display;
performing control to display one or more images on the display;
in response to one of the one or more images being selected as a selected image, performing control to display a first display item and a second display item at a position corresponding to the selected image;
if the first display item is tapped, switching a state regarding a first control between an enabled state and a disabled state;
if the second display item is tapped, switching a state regarding a second control between an enabled state and a disabled state;
if the first control is in the enabled state, performing the first control on the selected image in response to a specific touch operation on the selected image; and
if the second control is in the enabled state, performing the second control on the selected image in response to the specific touch operation.
